(19) United States
(12) Patent Application Publication
(10) Pub. No.: US 2007/0153667 A1
(43) Pub. Date: Jul. 5, 2007

(54) Visual target presenting optical device

(75) Inventors: Toshifumi Mihashi, Tokyo (JP); Yoko Hirohara, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOPCON

(21) Appl. No.: 11/607,855

(22) Filed: Dec. 4, 2006

(30) Foreign Application Priority Data
Dec. 5, 2005 (JP) 2005-351084

(51) Int. Cl. G11B 7/00

(52) U.S. Cl. 369/125

(57) ABSTRACT

A visual target presenting optical system has a light source that illuminates a visual target to be viewed by a subject, and a visual target presentation state changing unit that can change the direction in which the visual target will be presented to the subject. An alignment luminous flux casting unit casts an alignment luminous flux toward a subject eye at timing prior to the presentation of the visual target. An alignment light receiving optical system and a light receiving unit receive a reflected luminous flux from the subject eye reflecting the luminous flux. A change control unit instructs the visual target presentation state changing unit to change the visual target presenting direction on the basis of the light receiving position of the reflected luminous fluxes received by the light receiving unit.

### BACKGROUND OF THE INVENTION

1. Field of the Invention

This invention relates to a visual target presenting optical device, and particularly to a reduced-space visual target presenting optical device for testing the visual acuity of subject eyes.

2. Description of the Related Art

A predetermined test distance is necessary for optometry. However, a reduced-space optometric apparatus is proposed in which a test distance is optically provided by using a mirror or the like instead of linearly arranging subject eyes and a visual target (optometric table). An apparatus of this type has a relatively small mirror that reflects a visual target luminous flux toward subject eyes, and the subject views the visual target in the casing via the mirror. When a dedicated hand-held detector is held over the apparatus in accordance with the visual perception and a button switch is pressed, the apparatus receives that position and makes an adjustment by using the internal mirror or the like so that the visual target will be presented at a height at which the subject can view the visual target more easily, for example, as disclosed in Japanese Patent No.2,959,999.

Also, a subjective optometric apparatus having a visual target presenting device, a controller and a phoroptor that is horizontally symmetrical is disclosed, for example, in JP-A-2002-143092.

However, in the traditional apparatus, since the visual target is presented to the subject eyes by utilizing the reflection by the mirror as described above, it has low allowance with respect to a change in the positions of the subject eyes and a subject having a short trunk is forced to take an unnatural posture. Also, to adjust the height at which the visual target will be presented, the operation of holding the detector over the apparatus is necessary. If the subject eyes move during the measurement of subjective visual acuity or the like, the visual target may be presented at a position where it cannot be viewed easily. Therefore, there is a case that the position must be readjusted.

### SUMMARY OF THE INVENTION

In view of the foregoing circumstances, it is an object of this invention to provide a visual target presenting optical device that enables optometry in a proper state regardless of the physical conditions of the subject. It is another object of this invention to facilitate maintenance of the apparatus with a configuration that is as simple as possible, and accurately measure visual acuity. It is still another object of this invention to adjust the position (for example, height) where the visual target is presented by the apparatus, by detecting the position of the eye.

By detecting the position of the eye, the position (for example, height) where the visual target is presented by the apparatus is adjusted. The adjustment is made in two forms, that is, a full-automatic system, and a manual system in which, for example, the subject issues a trigger signal in a certain form when he/she wants to make an adjustment. Even in the manual system, the tester does not have to hold the traditional detector before the eye and can adjust the height of the eye simply by pressing a button on the bottom of an input device that inputs the response from the subject to the apparatus. Therefore, convenience at the time of measurement improves significantly. In the full-automatic system, instead of constantly chasing the eye, an adjustment is made at timing when the subject is not concentrating at the visual target in accordance with a typical pattern of eye movement. That is, an adjustment is made when a subjective test is automatically carried out by a computer interlocked with this adjustment mechanism.

The eye position can be detected, for example, by brightening the pupil of the eye using near infrared illumination. This is a technique of effectively utilizing the effect similar to “red-eye” experienced in ordinary photography. If a CCD is used in this detection of the eye position utilizing “red-eye”, measurement of the shape of the pupil area and the pupil diameter can be readily added. This is important because when it is used in combination with a wavefront aberrometer, a simulation based on wavefront aberration can be conducted accurately by finding the pupil diameter when the subject views the visual target.

Moreover, if a proper diaphragm is provided on the light receiving side, refractive measurement based on a retinoscope can be added to the detection of the eye position using “red-eye”. This can be considered to be a combination of the simultaneous refractive measurement at the time of subjective measurement with the measurement of the eye height.

According to the first solving means of this invention, there is provided a visual target presenting optical device comprising:

a visual target presenting optical system including a visual target to be viewed by a subject, a light source that illuminates the visual target, and a visual target presentation state changing unit that can change a direction in which the visual target will be presented to the subject;

an alignment luminous flux casting unit that casts a luminous flux for alignment toward a subject eye;

an alignment light receiving optical system for receiving a reflected luminous flux from the subject eye reflecting the luminous flux;

a light receiving unit that receives the reflected luminous flux via the alignment light receiving optical system;

a change control unit that controls the visual target presentation state changing unit on the basis of a light receiving position of the reflected luminous flux received by the light receiving unit, to change the direction of presentation of the visual target in the visual target presenting optical system; and

a device control unit that causes the alignment luminous flux casting unit to cast the luminous flux for alignment at timing prior to presentation of the visual target, causes the change control unit to control the visual target presentation state changing unit in accordance with the position of the reflected luminous flux acquired by the light receiving unit, and causes the visual target presenting optical system to present the visual target in the presenting direction.

According to the second solving means of this invention, there is provided a visual target presenting optical device comprising:

a visual target presenting optical system including a visual target to be viewed by a subject, a light source that illuminates the visual target, and a visual target presentation state changing unit that can change a direction in which the visual target will be presented to the subject;

a phoroptor or a test frame arranged in front of a subject eye and having a reflecting part or a part with a characteristic color;

an alignment luminous flux casting unit that casts a luminous flux for alignment toward the phoroptor or the test frame;

an alignment light receiving optical system for receiving a reflected luminous flux from the phoroptor or the test frame reflecting the luminous flux;

a light receiving unit that receives the reflected luminous flux via the alignment light receiving optical system;

a change control unit that controls the visual target presentation state changing unit on the basis of a light receiving position of the reflected luminous flux received by the light receiving unit, to change a direction of presentation of the visual target in the visual target presenting optical system; and

a device control unit that causes the alignment luminous flux casting unit to cast the luminous flux for alignment at timing prior to presentation of the visual target, causes the change control unit to control the visual target presentation state changing unit in accordance with the position of the reflected luminous flux acquired by the light receiving unit, and causes the visual target presenting optical system to present the visual target in the presenting direction.

According to this invention, it is possible to provide a visual target presenting optical device that enables optometry in a proper state regardless of the physical conditions of the subject. According to this invention, it is possible to facilitate maintenance of the apparatus with a configuration that is as simple as possible, and accurately measure visual acuity. According to this invention, it is possible to adjust the position (for example, height) where the visual target is presented by the apparatus, by detecting the position of the eye.

### BRIEF DESCRIPTION OF THE DRAWINGS

FIG. 1 is a perspective view showing a subjective optometric apparatus according to this invention.

FIG. 2 shows an exemplary internal structure of the subjective optometric apparatus shown in FIG. 1.

FIG. 3 shows an exemplary configuration of a rotary disc shown in FIG. 2.

FIG. 4 shows an exemplary rotary disc having a sun gear shown in FIG. 2.

FIG. 5 shows a schematic internal configuration of a visual target presenting device shown in FIG. 1.

FIGS. 6A to 6E show exemplary visual target charts presented by the visual target presenting device shown in FIG. 1, where FIG. 6A shows Landolt's ring patterns, FIG. 6B shows radial lines, FIG. 6C shows a group of dots, FIG. 6D shows a cross heterophoria chart, and FIG. 6E shows a non-perspective image.

FIG. 7 is a plan view showing an operating unit of a controller shown in FIG. 1.

FIG. 8 is a block diagram schematically showing the communication connection relation between the controller, phoroptor, liquid crystal display, and visual target presenting device shown in FIG. 1.

FIG. 9 shows a schematic internal configuration of the visual target presenting device.

FIGS. 10A and 10B are explanatory views of a light receiving signal to be received by a camera.

FIGS. 11A and 11B are explanatory views showing the visual target presenting timing and the alignment timing.

### DETAILED DESCRIPTION OF THE PREFERRED EMBODIMENTS

Hereinafter, embodiments of a subjective optometric apparatus (visual target presenting optical device) according to this invention will be described with reference to the drawings.

### 1. First Embodiment

### Phoroptor Type

Overall Configuration

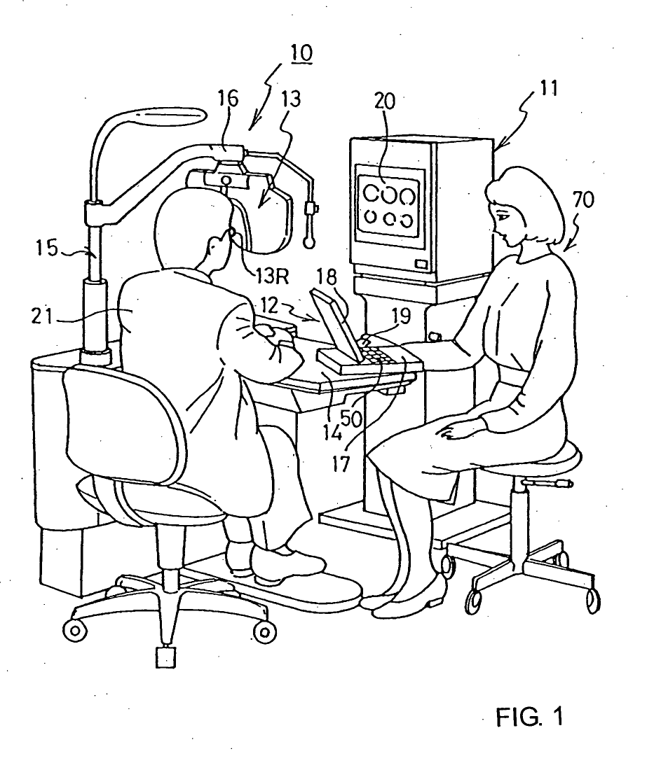

FIG. 1 is a perspective view showing a subjective optometric apparatus (see Japanese Patent No.2,959,999). In FIG. 1, 10 represents a subjective optometric apparatus. The subjective optometric apparatus 10 has a visual target presenting device 11, a controller 101, and a phoroptor 13 having a horizontally symmetrical shape.

Visual Target Presenting Device 11

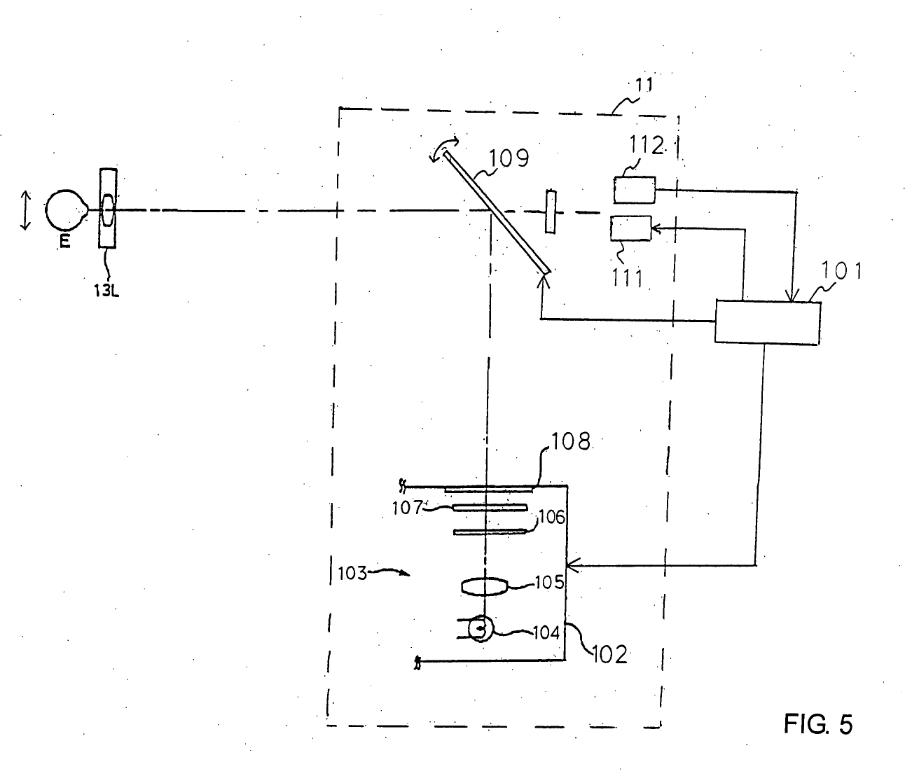

FIG. 5 shows a schematic internal configuration of the visual target presenting device. As shown in FIG. 5, the visual target presenting device 11 has a visual target optical system (visual target presenting optical system) 103, an illuminating unit (alignment flux casting unit) 111, a camera (light receiving unit) 112, and alignment light receiving optical system 103. The visual target optical system 103 has a light source 104, a condensing lens 105, a diffusion plate 106, a visual target panel 107, and a reflecting unit (visual target presentation state changing unit) 109. The reflecting unit 109 is supported with its angle being changeable so that the direction of a luminous flux from the visual target optical system 103 will be changed to the direction of the subject.

The visual target panel 107 is uniformly illuminated by the light source 104 and the diffusion plate 106. As the visual target panel 107, for example, plural types of panels are prepared and one of them is inserted into the optical path of the visual target optical system 103 by a switching mechanism, not shown, in accordance with the type of examination. The visual target panel 107 is reflected by the reflecting unit 109 and then presented to the subject through a visual target presenting window 108. The timing of presentation to the subject can be based on an instruction from the controller 101. The visual target 107 is changed properly so that, for example, the size changes as it is presented to the subject.

The reflecting unit 109 can change, for example, the direction of presenting the visual target 107 to the subject. The reflecting unit 109 is, for example, a band-pass filter that transmits the wavelength from the illuminating unit 111. In the example shown, the reflecting unit 109 reflects the light from the light source 104 and transmits the luminous flux from the illuminating unit 111 and the reflected luminous flux from the subject eyes. The reflecting unit 109 is rotationally driven in accordance with an instruction from the controller 101 (for example, a change control unit, which will be described later) and thus can change the direction of presenting the visual target. The presenting direction may be changed in the height direction of the visual target presentation, and it may also be changed in the left-and-right direction. Also, changes in the height direction and in the left-and-right direction may be combined. In this embodiment, the angle of reflection is changed by the reflecting unit 109. However, it is not limited to reflection and a transmission-type unit that can change the presenting direction may be used. The reflecting unit 109 can also be constructed to change the apparent size as viewed by the subject.

The illuminating unit 111 for illuminating the anterior parts of the subject eyes is provided on the surface of the visual target presenting device 11 that faces the subject. The illuminating unit 111 casts a luminous flux for alignment toward the subject eyes, for example, in accordance with an instruction from the controller 101. The illuminating unit 111 may have, for example, a light source that emits a luminous flux, and an optical system that guides the light from the light source to the subject eyes. To prevent miosis of the subject eyes, a near infrared ray or a luminous flux in a near infrared range is preferred. A near infrared light source is used for detecting the height of the eye, measuring the shape of the pupil area (measuring the pupil diameter), and measuring refraction in the retinoscope. The illuminating unit 111 may be installed in the phoroptor 13 in order to illuminate the anterior part of the eye.

The alignment light receiving optical system 103 is an optical system for receiving the reflected luminous fluxes from the subject eyes. Both the luminous flux from the illuminating unit 111 and the luminous fluxes reflected by the subject eyes to be received by the camera 112 may go through the alignment light receiving optical system 103. Alternatively, it is possible that the luminous flux from the illuminating unit 111 does not go through the alignment light receiving optical system 103 while the luminous fluxes reflected by the subject eyes to be received by the camera 112 go through the alignment light receiving optical system 103. Alternatively, it is possible that the luminous flux from the illuminating unit 111 goes through another optical system for casting a luminous flux to the subject eyes while the luminous fluxes reflected by the subject eyes to be received by the camera 112 go through the alignment light receiving optical system 103.

The camera 112 (observation unit) 112 for measuring the positions of the anterior parts of the subject eyes or the phoroptor 13 is provided. The camera 112 receives the reflected luminous flux received by the alignment light receiving optical system 103. The camera 112 may be a photo array or the like, or may be a proper light receiving device. The acquired image is inputted to the controller 101 and is processed by an image processing unit, which will be described later. The camera 112 may have a variable-magnification or zoom optical system including a wide angle for initially searching for the eye and a telescope for measuring the height of the eye accurately and for projecting the very size of the eye onto the CCD in order to measure refraction. A diaphragm may be provided in front of the camera 112.

In accordance with a light receiving signal from the camera 112, for example, the image processing unit of the controller 101 finds the position of the reflected light from the retina of the subject eye illuminated by the illuminating flux from the illuminating unit 111 (the positions of the subject eyes) and the positions of the subject eye windows 13L, 13R of the phoroptor 13, by image processing. For example, the reflected light from the retina of the subject eye is found or, the bright point of the subject eye's corneal reflection is found. In the case of the phoroptor 13, the positions of the subject eye windows 13L, 13R can be easily extracted if a characteristic color is arranged or a reflecting part is provided around the subject eye windows 13L, 13R. The direction of the vision of the subject can be known from the positional relation between the corneal bright point and the center of the pupil area.

In the example shown in FIG. 5, the luminous flux from the illuminating unit 111 and the luminous flux to be received by the camera are arranged to be transmitted through the reflecting unit. However, the illuminating unit 111 and the camera 112 may be arranged so that the luminous flux from the illuminating unit 111 and the luminous flux to be received by the camera will be reflected by the reflecting unit 109.

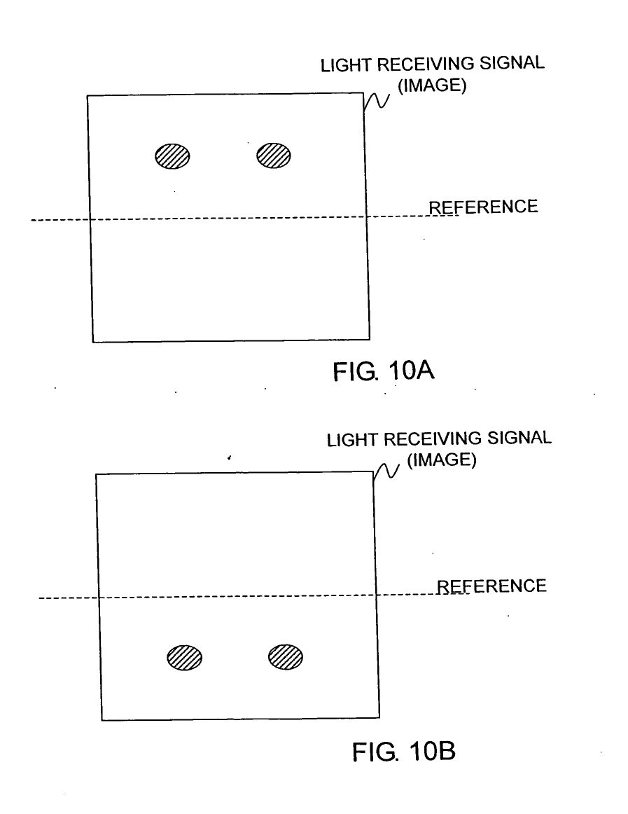

FIGS. 10A and 10B are explanatory views of a light receiving signal to be received by the camera 112. FIG. 10A shows an exemplary light receiving signal (light receiving image) in a case where the positions of the subject eyes are deviated upward. When the positions of the reflected luminous fluxes from the subject eyes (shaded parts in FIG. 10A) are deviated upward from the reference position, a change control unit 92 instructs the reflecting unit 109 to shift the visual target presenting position upward. Here, the reference position indicates, for example, the position where the visual target will be presented under the initial setting or at the present angle of the reflecting unit 109. For example, the position in the light receiving image in the camera 112 to which the height of the visual target to be presented corresponds, can be calibrated in advance.

FIG. 10B shows an exemplary light receiving signal (light receiving image) in a case where the positions of the subject eyes are deviated downward. When the positions of the reflected luminous fluxes from the subject eyes (shaded parts in FIG. 10B) are deviated downward from the reference position, the change control unit 92 instructs the reflecting unit 109 to shift the visual target presenting position downward.

The change control unit 92 may calculate the angle by which the reflecting unit is rotated, by using a predetermined rule and in accordance with the deviation from the reference position, may rotate the reflecting unit 109 by the calculated angle. For example, a method for calculating the rotation angle θ uses an equation θ=½ tan⁻¹(x/L), where L represents the distance from the phoroptor 13 to the reflecting unit 109 and x represents the amount of deviation of the subject eyes. Also, the processing unit may properly rotate the reflecting unit 109 upward or downward so that the positions of the reflected luminous fluxes from the subject eyes become the reference positions, with reference to the light receiving signal from the camera 112. In the example shown, the upward and downward deviations are described. However, deviations in the left-and-right direction can be detected by setting a reference position in the vertical direction, and the reflecting unit 109 can be rotated accordingly.

Controller 101

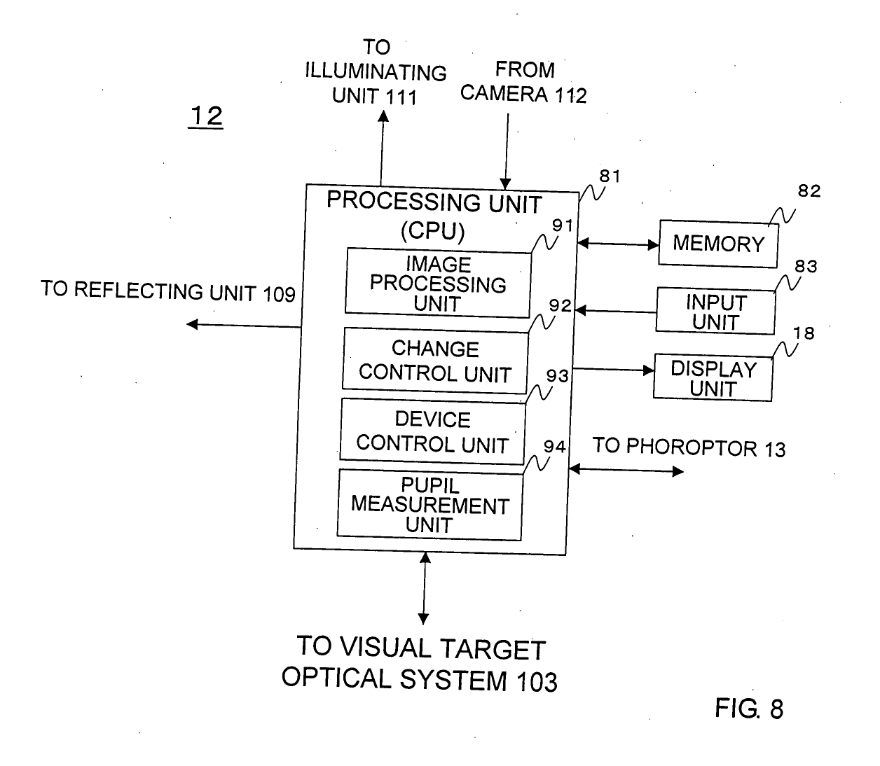

FIG. 8 schematically shows the controller 101.

The controller 101 has a processing unit (CPU) 81, a memory 82, an input unit 83, and a display unit 18. The controller 101 may also have an output unit that outputs sound, and a proper interface. The processing unit 81 has, for example, an image processing unit 91, a change control unit 92, and a device control unit 93. The processing unit 81 may further include a pupil measurement unit 94.

The processing unit 81 is connected, for example, with the driving control unit of the phoroptor 13, the driving control unit of the visual target presenting device 11 and the like via an interface. Pulse motors M1 to M6 of the phoroptor 13 are controlled in accordance with registered test contents of the controller 101. The driving control unit of the visual target presenting device 11 is similarly controlled.

The image processing unit 91 finds the positions of the subject eyes by image processing based on the signal from the camera 112 of the visual target presenting device 11. On the basis of the light receiving position of the reflected luminous fluxes received by the camera 112, the change control unit 92 instructs the reflecting unit 109 to change the presentation state of the visual target 107 by the visual target optical system 103. The pupil measurement unit 94 measures the pupil area and/or pupil diameter based on the signal from the camera 112.

The device control unit 93 controls the illumination of the illuminating unit 111, the illumination of the light source 104 and the like. For example, the device control unit 93 controls the illuminating unit 111 to emit an alignment luminous flux at timing prior to the presentation of the visual target, and controls the reflecting unit 109 to change the visual target presenting direction in accordance with the positions of the resulting reflected luminous fluxes. For example, the device control unit 93 can first turn on the illuminating unit 111 to illuminate the subject eyes, then turn off the illuminating unit 111 and turn on the light source 104, thereby presenting the visual target 107 to the subject eyes. The timing of the control for change can be the timing of changing the visual target. Also, this timing can be the timing of every input from the subject. The reflecting unit 109 can be constructed to be controlled so that the visual target presenting direction will be changed every time an input is made by the subject or the operator of the controller. The input from the subject may be, for example, the subject's response to the presentation of the visual target.

The pupil measurement unit 94 finds the pupil area and/or pupil diameter based on the light receiving signal from the camera 112. For example, the pupil area and/or pupil diameter are found by determining the area corresponding to red-eye and its size.

The input unit 83 has, for example, an operation panel 17 and a mouse 19. As the display unit 18, for example, a liquid crystal display panel for a monitor can be used. Selection of a visual target chart 20 of the visual target presenting device 11 and control of the phoroptor 13 can be carried out by the operation panel 17 and the mouse 19. In the memory 82, for example, a control program, a test program, the light receiving signal from the camera 112 and the like are stored.

In the example of FIG. 1, the controller 101 is set on an optometric table 14. The optometric table 14 is provided with a supporting pole 15 that is vertically extensible, and a supporting arm 16 is provided rotatably on the supporting pole 15. The phoroptor 13 is supported by the supporting arm 16.

Phoroptor 13

Optometric windows 13L, 13R are provided in the phoroptor 13. A subject 21 views the visual target chart 20 through the optometric windows 13L, 13R to receive a visual acuity test.

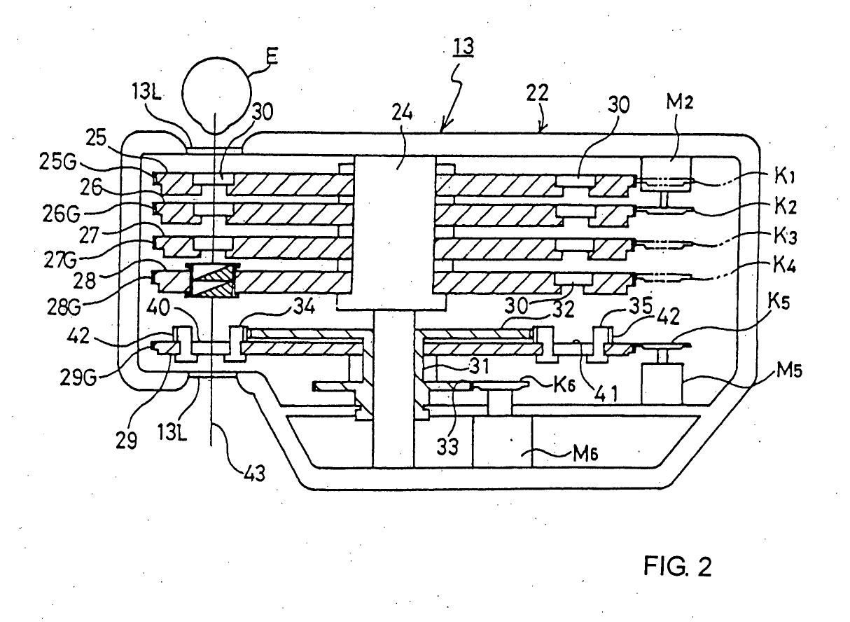

FIG. 2 shows an exemplary internal structure of the phoroptor (see Japanese Patent No.2,959,999). Since the phoroptor 13 has a horizontally symmetrical structure as is known, only the left part (part for testing the left eye E of the subject 21) will be described with reference to FIG. 2.

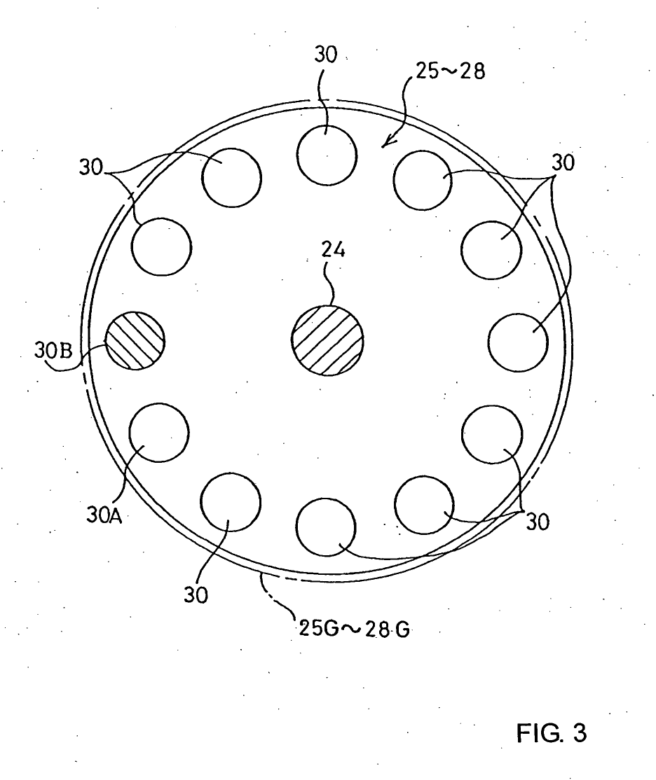

In FIG. 2, 22 represents the case of the left-eye corresponding part. In the case 22, a shaft 24 is provided and rotary discs 25 to 29 are rotatably provided on the shaft 24. In each of the rotary discs 25 to 29, circular apertures 30 are provided at equal intervals in the circumferential direction, and gears 25G to 29G are formed on the outer circumferential parts of the rotary discs 25 to 29, as shown in FIG. 3 (see Japanese Patent No.2,959,999).

The gears 25G to 29G are meshed with driving gears K1 to K5. The driving gears K1 to K5 are rotationally driven by pulse motors M1 to M5 (M1 to M4 are not shown in FIG. 2).

In the plural circular apertures 30 of the rotary disc 25, plural refractive power lenses having refractive powers that differ by 0.25 D each are fitted as optical elements for testing, with one refractive power lens being fitted in one circular aperture each. In the plural circular apertures 30 of the rotary disc 26, plural refractive power lenses having refractive powers that differ by 3 D each are fitted, with one refractive power lens being fitted in one circular aperture each. In each of the circular apertures 30 of the rotary disc 27, an astigmatic lens is fitted as an optical element for testing. In the circular apertures 30 of the rotary. disc 28, a light shielding plate, a pin hole, a Maddox lens, a red filter, a green filter (red-green filter), and a rotary prism are fitted, respectively, as auxiliary optical elements for testing.

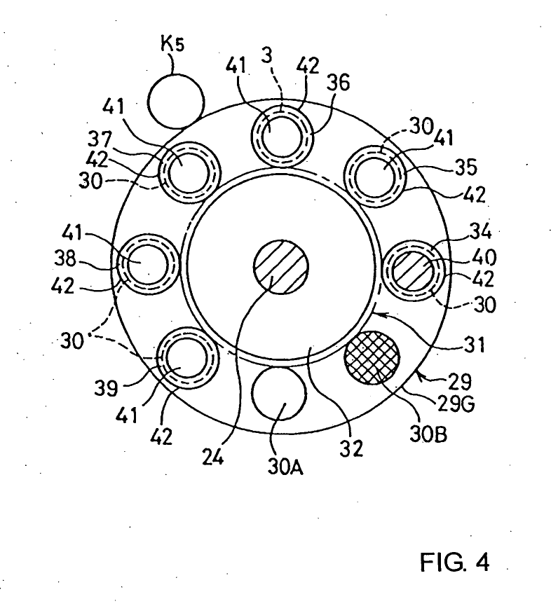

FIG. 4 shows an exemplary rotary disc having a sun gear (see Japanese Patent No.2,959,999). In the rotary disc 29, cross cylinders 41 for conducting a cross cylinder test, a polarizer 40 and a light shielding plate 30B are mounted.

The rotary disc 29 has a sun gear 31. The sun gear 31 includes a large-size gear 32 and a small-size gear 33 as shown in FIG. 2. A driving gear K6 is meshed with the small-size gear 33, and the small-size gear 33 is rotationally driven by a pulse motor M6.

On the circular apertures 30 of the rotary disc 29, holders 34, 35 to 39 are rotatably provided as shown in FIG. 4. The polarizer 40 as an auxiliary optical element for testing is provided in the holder 34. The cross cylinders 41 having different powers as optical elements for testing are provided in the holders 35 to 39.

Gears 42 are provided on the outer circumferential parts of the holders 34 to 39. Each gear 42 is meshed with the large-size gear 33, and the holders 34 to 39 can be rotated about a test optical axis 43 by the pulse motor M6.

Of the circular apertures 30 of each of the rotary discs 25 to 29, at least one is a through aperture having nothing provided therein in order to test the subject eyes without applying correction. In FIG. 3 and FIG. 4, the through aperture 30 is denoted by a reference numeral 30A. In the circular aperture 30 next to the through aperture 30A of each of the rotary discs 25 to 29, the light shielding plate 30B is provided to prevent the subject 21 from viewing the visual target chart 20.

The direction of polarization by the polarizer 40 for testing the left eye is set at 135 degrees to the horizontal direction in the reference position. On the other hand, the direction of polarization by the polarizer for testing the right eye (not shown) is set at 45 degrees. The polarizer for the left eye and the polarizer for the right eye are set in the optometric windows 13L, 13R, with these polarizers being orthogonal to each other.

The phoroptor 13 is arranged before the subject eyes and may have a reflecting part or a part having a characteristic color. For example, a reflecting part that reflects luminous fluxes can be provided near the subject eye windows that transmit the luminous fluxes to the subject eyes, and the reflected luminous fluxes (position of the phoroptor) acquired from the reflecting part reflecting the luminous flux from the illuminating unit 111 can be detected from the light receiving signal (image) acquired by the camera 112. Alternatively, for example, a part having a characteristic color that can be discriminated from the other parts can be provided near the subject eye windows that transmit the luminous fluxes to the subject eyes, and the characteristic color can be detected from the light receiving signal (image) acquired by the camera 112, thereby detecting the position of the phoroptor. The reflecting part and the color part may be provided at other predetermined positions than near the subject eye windows.

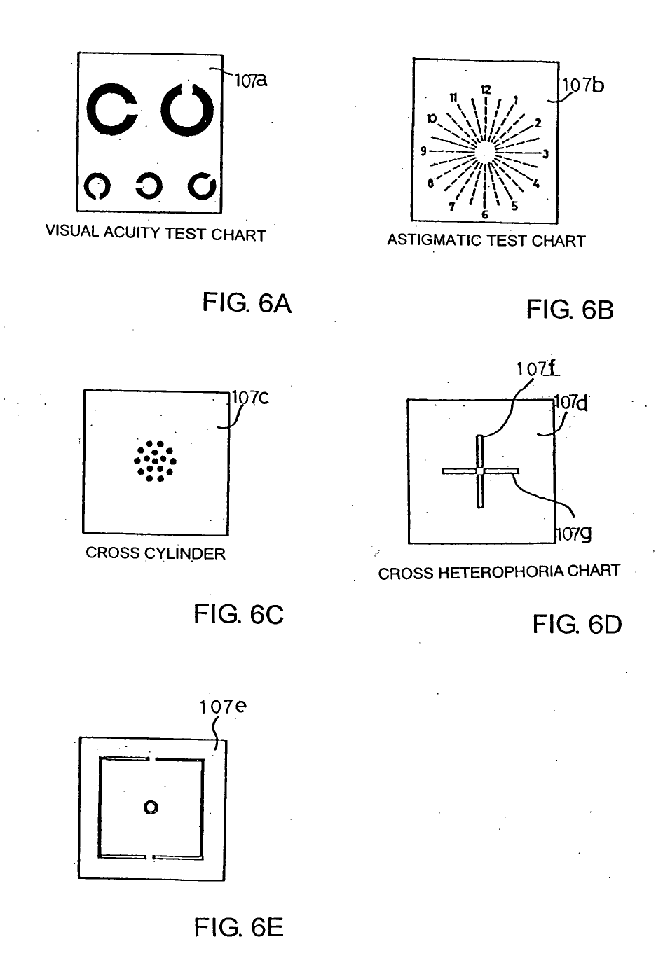

FIGS. 6A to 6E show exemplary visual target charts presented by the visual target presenting device (see Japanese Patent No.2,959,999).

In the visual target panel 107, for example, a Landolt's ring pattern chart 107a as shown in FIG. 6A, an astigmatic test chart 107b as shown in FIG. 6B, a cross cylinder test chart (dot group chart) 107c as shown in FIG. 6C, a cross heterophoria chart 107d as shown in FIG. 6D, and a non-perspective chart 107e as shown in FIG. 6E are prepared.

Polarization filters are attached to the cross heterophoria chart 107d and the non-perspective chart 107e. For example, in the cross heterophoria chart 107d, a polarization filter having a direction of polarization of 45 degrees to the horizontal direction is attached to its vertical line part 107f, and a polarization filter having a direction of polarization of 135 degrees to the horizontal direction is attached to its horizontal line part 107g.

Operating Unit 50

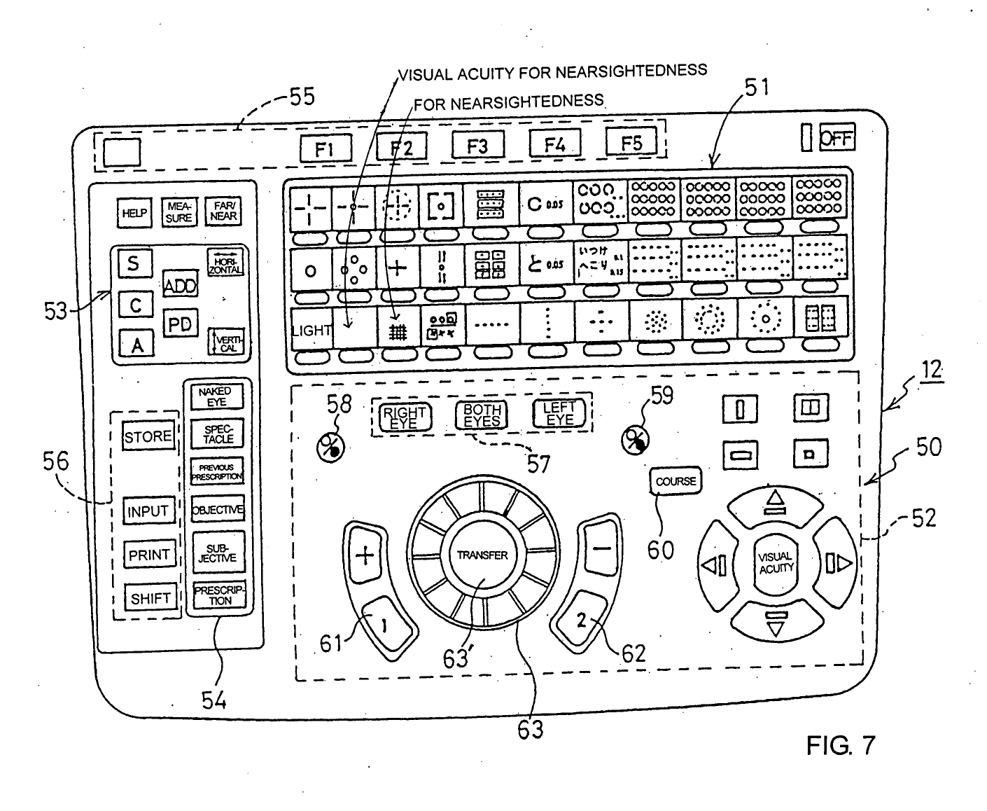

FIG. 7 is a plan view showing an operating unit of the controller (see Japanese Patent No.2,959,999). The operation panel 17 of the controller 101 has an operating unit 50. This operating unit 50 has a chart selection switch part 51, a basic operation switch part 52, a function selection switch part, a comparison switch part 54, and special function switch parts 55, 56, as shown in an enlarged manner in FIG. 7.

The chart selection switch part 51 includes a group of switches for designating visual target charts. When one of the switches of this group is operated, the visual target panel 107 corresponding to the operated switch is inserted into the optical path of the visual target optical system 103, and the corresponding visual target chart is displayed on the screen of the liquid crystal display panel 18.

The basic operation switch part 52 has a group of switches for testing the refractive power, degree of astigmatism and astigmatic axis, and a group of switches for conducting a cross cylinder test. For example, these include a measurement eye designation switch 57, a left eye opening/closing switch 58, a right eye opening/closing switch 59, a test course designation switch 60, a “1” switch 61, a “2” switch 62, a dial 63, and other switches.

The measurement eye designation switch 57 is a switch for selecting the left eye, the right eye or both eyes as the measurement eye(s). The left eye opening/closing switch 58 is a switch for inserting the light shielding plate into the optometric window 13L and thus preventing the left eye of the subject from viewing the visual target chart 20. The right eye opening/closing switch 58 is a switch for inserting the light shielding plate into the optometric window 13R and thus preventing the right eye of the subject from viewing the visual target chart 20. The test course designation switch 60 is a switch for starting a program. As the test course designation switch 60 is pressed, a list of executable programs is displayed on the screen of the liquid crystal display panel 18.

The “1” switch 61 and the “2” switch 62 are used for driving the cross cylinder lens for testing an astigmatic axis and testing the degree of astigmatism. The dial 63 is used mainly for rotating the rotary discs 25 to 28 in the phoroptor 13 and switching the test optical elements arranged in the optometric windows 13L, 13R. The transfer switch 63′ is a switch for shifting the optometry program from the currently conducted test to the next test.

As the test course designation switch 60 is pressed, a list of test courses that have been registered in advance is displayed on the screen of the liquid crystal display panel 18. When a specific test program is selected from the list by the mouse 19, that test course will be executed. The procedure of the test program is not directly related with this invention and therefore will not be described further in detail.

As the test program is selected by the operating unit 50, the device control unit 93 causes the illuminating unit 111 to cast illuminating light to the subject eyes before starting the test course. The camera unit 112 receives the reflected luminous fluxes from the anterior parts of the subject eyes or the subject eye windows 13L, 13R of the phoroptor. The image processing unit 91 of the CPU 101 inputs the light receiving signal from the camera 112 and finds the positions of the anterior parts of the subject eyes or the subject eye windows 13L, 13R of the phoroptor by image processing based on the light receiving signal. In accordance with the result of this, the change control unit 92 adjusts the reflecting unit 109 supported with its angle being changeable, to a proper angle. In this case, if the reflected light from the retina is captured, the pupil measurement unit 94 can measure the shape of the pupil area and the pupil diameter. Also, if wavefront aberration of the eyes is separately measured on the basis of the result, refraction can be calculated from the pupil diameter at this point, and it can be accurately compared with objective measurement. If a knife edge is provided before the camera 112, refractive measurement of the subject eyes can be carried out by a retinoscope. Also, on the basis of this value, the degree of a trial lens at the time of starting subjective optometry can be decided.

In the memory 82 of the controller 101, an execution program for executing the test course and a registration program for registering in advance the test course to be executed are stored.

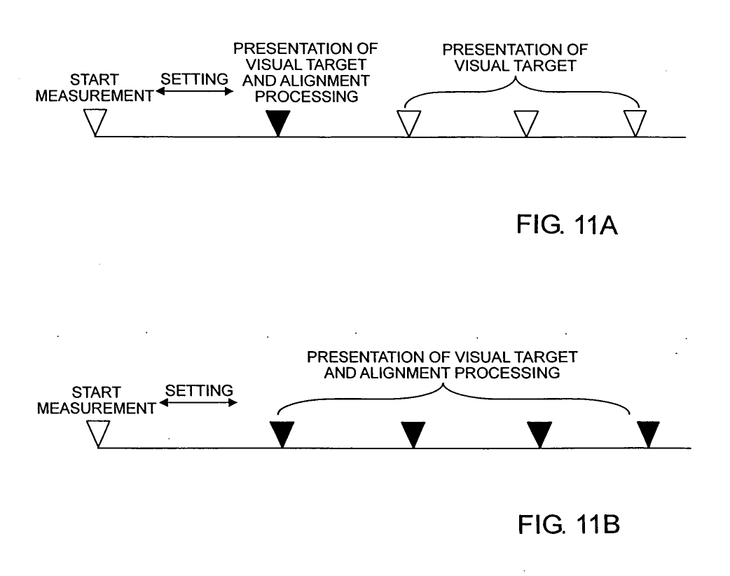

In the case of manually selecting a visual target without using test courses, the device control unit 93 causes the illuminating unit 111 to cast illuminating light before the visual target changes at the time of each selection, and finds the positions of the anterior parts of the subject eyes or the subject eye windows 13L, 13R of the phoroptor by image processing based on the light receiving signal from the camera unit 112. In accordance with the result of this, the reflecting unit 109 supported with its angle being changeable is adjusted to a proper angle. FIGS. 11A and 11B are explanatory views showing the visual target presentation timing and the alignment timing. In the case shown in FIG. 11A, as the measurement is started, the phoroptor is set in front of the subject and alignment is made approximately at the same timing as the presentation of the first visual target. In the case of presenting the subsequent visual targets, changes visual targets are presented. Next, in the case shown in FIG. 11B, as the measurement is started, the phoroptor is set in front of the subject and alignment is made approximately at the same timing as the presentation of the first visual target. In the case of presenting the subsequent visual targets, alignment is made each time.

If the positions of the subject eyes cannot be detected (for example, if the reflected luminous fluxes from the retina of the subject eye cannot be detected in the light receiving image), the device control unit 93 generates a sign (for example a beep sound or like sound, or a display) to notify the tester of the inability to detect, and thus can facilitate the subject to shift the subject eyes to proper positions.

### 2. Second Embodiment

### Test Frame Type

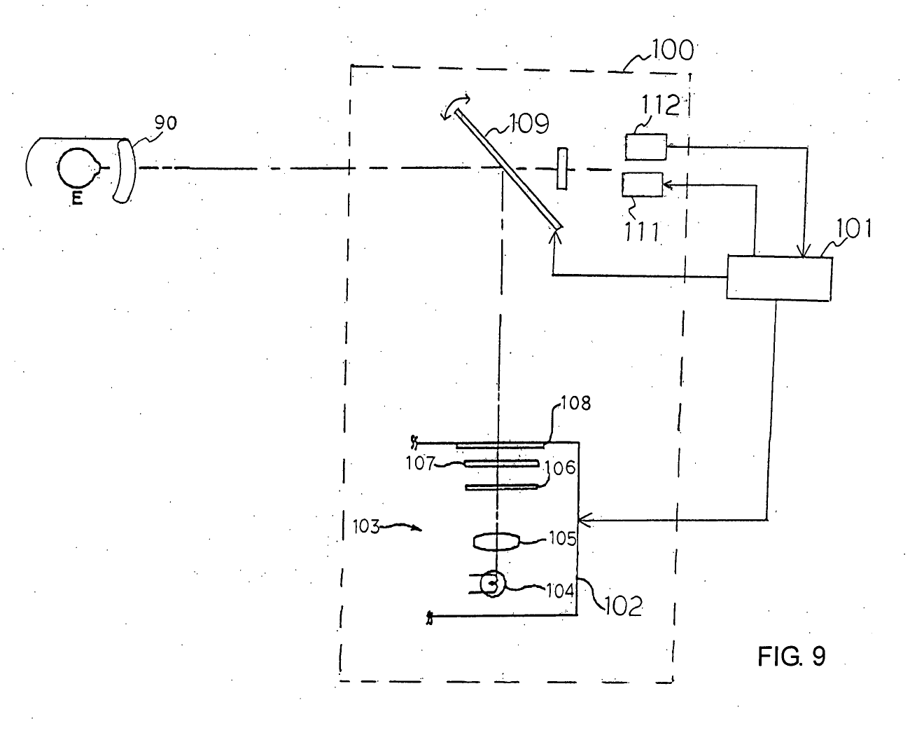

FIG. 9 schematically shows the internal configuration of a visual target presenting device 11 according to a second embodiment.

The phoroptor 13 is used in the first embodiment. However, also in the case of using a test frame for subjective optometry, the positions of the eyes can be detected at predetermined timing and angle adjustment can be made by a similar technique. Thus, the direction can be adjusted to the optimum positions of the subject eyes.

The subjective optometric apparatus 10 has the visual target presenting device 11, the controller 101, and a test frame 95. The test frame 95 is equivalent to the phoroptor of the first embodiment. The test frame 95 has properly includes a refractive power lens, an astigmatic lens, a light shielding plate and the like, similarly to the phoroptor of the first embodiment.

The test frame is arranged in front of the subject eyes and may have a reflecting part or a part having a characteristic color. For example, a reflecting part that reflects light can be provided at a predetermined position on the frame, and the reflected luminous flux (position of the test frame) acquired by reflecting the luminous flux from the illuminating unit 111 can be detected from the light receiving signal (image) acquired by the camera 112. Alternatively, for example, a part having a characteristic color that can be discriminated from other parts can be provided at a predetermined position on the frame, and the characteristic color can be detected from the light receiving signal (image) acquired by the camera 112, thereby detecting the position of the test frame.

The other parts of the configuration are similar to those of the first embodiment and therefore will not be described further in detail. If the positions of the subject eyes cannot be detected (for example, if the reflected luminous fluxes from the retina of the subject eye cannot be detected in the light receiving image), the device control unit 93 generates a sign (for example a beep sound or like sound, or a display) to notify the tester of the inability to detect, and thus can facilitate the subject to shift the subject eyes to proper positions.

This invention can be applied to, for example, industries related to devices for testing visual acuity.

What is claimed is:

1. A visual target presenting optical device comprising:
a visual target presenting optical system including a visual target to be viewed by a subject, a light source that illuminates the visual target, and a visual target presentation state changing unit that can change a direction in which the visual target will be presented to the subject;
an alignment luminous flux casting unit that casts a luminous flux for alignment toward a subject eye;
an alignment light receiving optical system for receiving a reflected luminous flux from the subject eye reflecting the luminous flux;
a light receiving unit that receives the reflected luminous flux via the alignment light receiving optical system;
a change control unit that controls the visual target presentation state changing unit on the basis of a light receiving position of the reflected luminous flux received by the light receiving unit, to change the direction of presentation of the visual target in the visual target presenting optical system; and
a device control unit that causes the alignment luminous flux casting unit to cast the luminous flux for alignment at timing prior to presentation of the visual target, causes the change control unit to control the visual target presentation state changing unit in accordance with the position of the reflected luminous flux acquired by the light receiving unit, and causes the visual target presenting optical system to present the visual target in the presenting direction.

2. A visual target presenting optical device comprising:
a visual target presenting optical system including a visual target to be viewed by a subject, a light source that illuminates the visual target, and a visual target presentation state changing unit that can change a direction in which the visual target will be presented to the subject;
a phoroptor or a test frame arranged in front of a subject eye and having a reflecting part or a part with a characteristic color;
an alignment luminous flux casting unit that casts a luminous flux for alignment toward the phoroptor or the test frame;
an alignment light receiving optical system for receiving a reflected luminous flux from the phoroptor or the test frame reflecting the luminous flux;
a light receiving unit that receives the reflected luminous flux via the alignment light receiving optical system;
a change control unit that controls the visual target presentation state changing unit on the basis of a light receiving position of the reflected luminous flux received by the light receiving unit, to change a direction of presentation of the visual target in the visual target presenting optical system; and
a device control unit that causes the alignment luminous flux casting unit to cast the luminous flux for alignment at timing prior to presentation of the visual target, causes the change control unit to control the visual target presentation state changing unit in accordance with the position of the reflected luminous flux acquired by the light receiving unit, and causes the visual target presenting optical system to present the visual target in the presenting direction.

3. The visual target presenting optical device according to claim 1, wherein the visual target is a visual target for measuring visual acuity.

4. The visual target presenting optical device according to claim 1, wherein the timing is timing immediately before changing the visual target.

5. The visual target presenting optical device according to claim 1, further comprising
an input unit that inputs an instruction from the subject or a response to the presentation of the visual target,
wherein
the timing occurs every input from the subject, and
the visual target presentation state changing unit is controlled to change the direction of presentation of the visual target every input from the subject.

6. The visual target presenting optical device according to claim 1, wherein the visual target presentation state changing unit changes a height direction and/or a left-and-right direction of the presentation of the visual target.

7. The visual target presenting optical device according to claim 1, wherein the visual target presentation state changing unit changes an apparent size as viewed by the subject.

8. The visual target presenting optical device according to claim 1, further comprising a pupil measurement unit that measures a pupil area and/or a pupil diameter on the basis of the reflected luminous flux received by the light receiving unit.

9. The visual target presenting optical device according to claim 1, wherein the device control unit outputs a sign to notify the subject of an inability to detect or a sign to facilitate the subject to move the eye to a proper position in the case that the position of the subject eye cannot be detected on the basis of the light receiving position where the light is received by the light receiving unit.

10. The visual target presenting optical device according to claim 1, wherein the alignment luminous flux casting unit emits a near infrared ray or light in a near infrared range.

11. The visual target presenting optical device according to claim 1, wherein
the visual target presentation state changing unit reflects the luminous flux from the light source that illuminates the visual target and, rotates degrees in accordance with the light receiving position where the light is received by the light receiving unit, on the basis of an instruction from the change control unit, thereby changing the direction of presenting the visual target.

12. The visual target presenting optical device according to claim 2, wherein the visual target is a visual target for measuring visual acuity.

13. The visual target presenting optical device according to claim 2, wherein the timing is timing immediately before changing the visual target.

14. The visual target presenting optical device according to claim 2, further comprising
an input unit that inputs an instruction from the subject or a response to the presentation of the visual target,
wherein
the timing occurs every input from the subject, and
the visual target presentation state changing unit is controlled to change the direction of presentation of the visual target every input from the subject.

15. The visual target presenting optical device according to claim 2, wherein the visual target presentation state changing unit changes a height direction and/or a left-and-right direction of the presentation of the visual target.

16. The visual target presenting optical device according to claim 2, wherein the visual target presentation state changing unit changes an apparent size as viewed by the subject.

17. The visual target presenting optical device according to claim 2, further comprising a pupil measurement unit that measures a pupil area and/or a pupil diameter on the basis of the reflected luminous flux received by the light receiving unit.

18. The visual target presenting optical device according to claim 2, wherein the device control unit outputs a sign to notify the subject of an inability to detect or a sign to facilitate the subject to move the eye to a proper position in the case that the position of the subject eye cannot be detected on the basis of the light receiving position where the light is received by the light receiving unit.

19. The visual target presenting optical device according to claim 2, wherein the alignment luminous flux casting unit emits a near infrared ray or light in a near infrared range.

20. The visual target presenting optical device according to claim 2, wherein
the visual target presentation state changing unit reflects the luminous flux from the light source that illuminates the visual target and, rotates degrees in accordance with the light receiving position where the light is received by the light receiving unit, on the basis of an instruction from the change control unit, thereby changing the direction of presenting the visual target.
